(19) United States
(12) Patent Application Publication
(10) Pub. No.: US 2014/0093624 A1
(43) Pub. Date: Apr. 3, 2014

(54) Controlled-Break Tostada and Taco Shell

(71) Applicant: Guillermo Trevino, Carrollton, TX (US)

(72) Inventor: Guillermo Trevino, Carrollton, TX (US)

(21) Appl. No.: 13/632,079

(22) Filed: Sep. 30, 2012

(51) Int. Cl. A21D 8/02; A21D 13/00

(52) U.S. Cl. 426/138; 426/502; 426/439; 426/560

(57) ABSTRACT

The present invention relates to a method of making a controlled-break tostada or taco and the actual controlled-break tostada or taco. The method of making a controlled-break tostada comprises sheeting tostada dough onto a flat surface in a machine, directing the tostada dough on the flat surface in the machine to a cutting device, cutting break-points throughout surface of the tostada dough with the cutting device, and heating the tostada dough.

### FIELD OF THE INVENTION

The present invention relates generally to the field of snacks and fast food products industries and it comprises both the method of producing the corresponding product and also the product itself, and more particularly relates to a method of making a controlled-break tostada or taco and the actual controlled-break tostada or taco.

### BACKGROUND OF THE INVENTION

In the very competitive food industry it has become very desirable to prepare and sell food products that are easily prepared and served. Some of the more popular food items with these characteristics are the taco or tostada. Both food items utilize a hard, crisp tortilla stuffed or layered with ground meat, lettuce, tomato and/or cheese. Although it is easily prepared and served, it is extremely messy to eat as the stuffing matter inside or on top of the tostada or taco shell has a tendency to spill because the hard, crisp tortilla has a tendency to crumble with uneven edges thus allowing the stuffing matter to fall out of the tostada or taco shell. A tortilla shell that would create even breaks when one bites into a tostada or taco would be desirable in this context.

Tacos are very popular in the fast food restaurant business; however, the tostada is not a food easily found at a drive-through restaurant as they are messy to eat since the product breaks unpredictably when the customer takes a bite of a tostada. The present invention may open the doors to further usage in this context since the controlled-break tostada would enhance the portability of the product. By enhancing the portability of the tostada to solve the messiness issue of the tostada, this would allow the product to be sold in the context of a drive-through restaurant or at sporting events. The controlled-break tostada makes the product much easier to consume not only at home, but also away from the home at restaurants, sporting events, drive through restaurants, and etc.

There are tostada and taco shells that are designed to enhance portability, but many of them utilize drastically different designs and concepts in order to prevent spillage of the stuffing matter within a tostada or taco shell. Certain patent applications have utilized taco cones or different structural designs to enhance the portability of the tostada or taco shell. However, in these structural design changes, the taco cone or structural change may lose the traditional feel of this long-time culinary favorite. A tostada or taco shell that retained its traditional structure while also enhancing the portability of the food product would be desirable in this context. U.S. Pat. No. 5,009,902 of Mercenari describes a conical taco shell, which utilizes a different structural design and does not utilize the controlled-break aspect in the context of a taco shell.

Therefore, there is a need to provide a controlled-break tostada or taco shell, which prevents the tostada or taco shell from breaking unevenly and having its toppings spill over with its break-points through the surface of the tortilla shell.

### SUMMARY

The foregoing needs are met, to a great extent, by the present invention, wherein in some embodiments a method, a controlled-break tostada, and a controlled-break taco shell are provided.

An embodiment of the present invention relates to a method of making a controlled-break tostada comprising sheeting tostada dough onto a flat surface in a machine, directing the tostada dough on the flat surface in the machine to a cutting device, cutting break-points throughout surface of the tostada dough with the cutting device, and heating the tostada dough.

Another embodiment of the present invention relates to a controlled-break tostada comprising break-points throughout surface of the tostada with a separation within a range of 0.20 cm to 0.30 cm between each other.

Yet another embodiment of the present invention relates to a controlled-break taco shell comprising break-points throughout surface of the taco shell with a separation within a range of 0.20 cm to 0.30 cm between each other.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for other methods for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

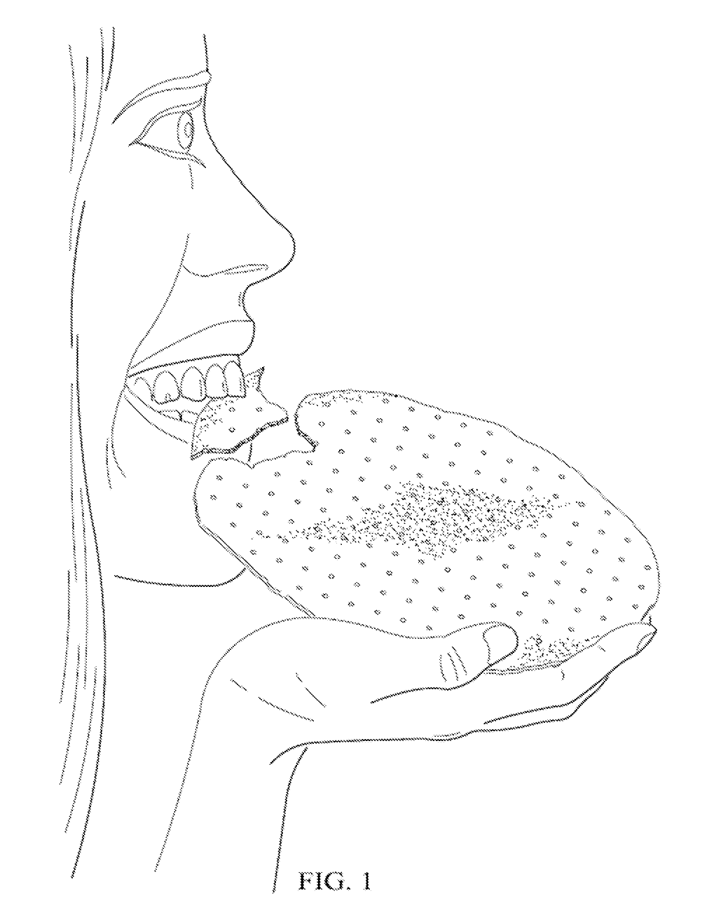

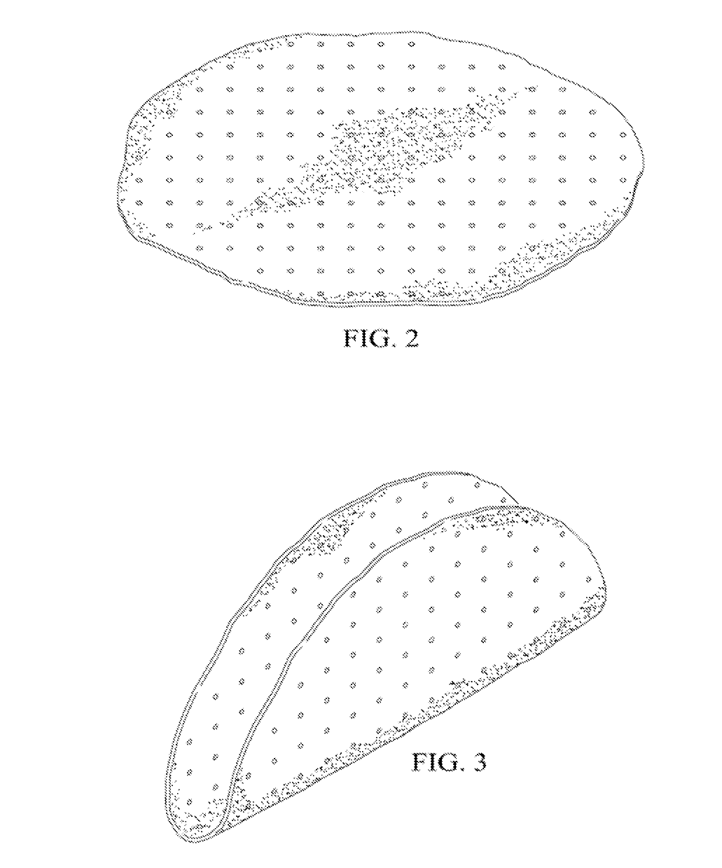

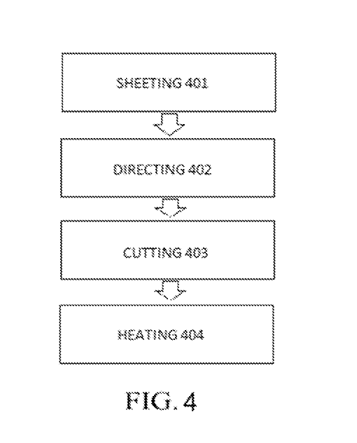

The novel features believed characteristic of the invention are set forth in the appended claims. The present invention and other attributes of the invention can best be understood in connection with the accompanying drawing in which: FIG. 1 is a diagram depicting a side view of a facial profile of a user with the present invention in use; FIG. 2 is a diagram depicting a perspective view of the controlled-break tostada, an embodiment of the current invention; FIG. 3 is a diagram depicting a perspective view of the controlled-break taco, an embodiment of the current invention; and FIG. 4 is a block diagram depicting components for a method of making a controlled-break tostada.

### DETAILED DESCRIPTION OF EXEMPLARY EMBODIMENTS

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing the spirit or scope of the invention. To avoid detail not necessary to enable those skilled in the art to practice the embodiments, the description may omit certain information known to those skilled in the art. The following detailed description is, therefore, not to be taken in a limiting sense.

With reference now to FIG. 1 a diagram depicts a side view of a facial profile of a user with the present invention in use. In order to create the controlled breaks shown in the tostada, a method of making a controlled-break tostada is necessary. The method of making a controlled-break tostada comprises sheeting tostada dough onto a flat surface in a machine, directing the tostada dough on the flat surface in the machine to a cutting device, cutting break-points throughout surface of the tostada dough with the cutting device and heating the tostada dough. The final product as shown here utilizes such a method.

With reference now to FIG. 2, a diagram depicts a perspective view of the controlled-break tostada, an embodiment of the current invention. A controlled-break tostada comprising a tostada with break-points throughout surface of the tostada with a separation within a range of 0.20 cm to 0.30 cm between each other. The controlled-break tostada further comprises a diameter in a range from about 4 inches to about 16 inches from a circular edge of the tostada to an opposite circular edge. The controlled-break tostada further comprises tostada dough selected from a group of corn-based dough, wheat-based dough, rice-based dough, and any combinations thereof.

With reference now to FIG. 3, a diagram depicts a perspective view of the controlled-break taco, an embodiment of the current invention. A controlled-break taco shell comprising a taco with break-points throughout surface of the taco shell with a separation within a range of 0.20 cm to 0.30 cm between each other. The controlled-break taco shell further comprises a diameter in a range from about 4 inches to about 16 inches from a circular edge of the taco shell to an opposite circular edge. The controlled-break taco shell further comprises taco shell dough selected from a group of corn-based dough, wheat-based dough, rice-based dough, and any combinations thereof.

With reference now to FIG. 4, a block diagram depicting components for a method of making a controlled-break tostada. In order to create the controlled breaks shown in the tostada, a method of making a controlled-break tostada is necessary. The method of making a controlled-break tostada comprises four steps as shown in the block diagram: sheeting 401, directing 402, cutting 403, and heating 404. Sheeting 401 comprises sheeting tostada dough onto a flat surface in a machine. Directing 402 comprises directing the tostada dough on the flat surface in the machine to a cutting device. Cutting 403 comprises cutting break-points throughout surface of the tostada dough with the cutting device. Heating 404 comprises heating the tostada dough. The embodiments in FIG. 1, FIG. 2, and FIG. 3 as shown above utilize such a method. The method of making a controlled-break tostada may comprise tostada dough which is selected from a group of corn-based dough, wheat-based dough, rice-based dough, and any combinations thereof. The method of making a controlled-break tostada may comprise tostada dough which comprises a taco shell to be to used to create a controlled-break taco shell. The taco shell dough may be selected from a group of corn-based dough, wheat-based dough, rice-based dough, and any combinations thereof. Cutting 403 may further comprise a step wherein cutting the break-points throughout the surface of the tostada dough with the cutting device further comprises placing holes with a separation within a range of 0.20 cm to 0.30 cm between each other. Heating 404 may further comprise baking the tostada dough in an oven. Heating 404 may also comprise a step of frying the tostada dough in a fry machine.

While the present invention has been described with reference to particular embodiments, it will be understood that the embodiments are merely illustrative and that the invention scope is not so limited. Any variations, modifications, additions, and improvements to the embodiments described are possible. These variations, modifications, additions, and improvements may fall within the scope of the inventions as detailed within the following claims.

Insofar as the description above and the accompanying drawings disclose any additional subject matter that is not within the scope of the single claim below, the illustrative embodiments are not dedicated to the public and the right to file one or more applications to claim such additional embodiments is reserved.

What is claimed is:

1. A method of making a controlled-break tostada comprising:
Sheeting tostada dough onto a flat surface in a machine;
Directing the tostada dough on the flat surface in the machine to a cutting device;
Cutting break-points throughout surface of the tostada dough with the cutting device; and
Heating the tostada dough.

2. The method of claim 1 wherein the tostada dough is selected from a group of corn-based dough, wheat-based dough, rice-based dough, and any combinations thereof.

3. The method of claim 1 wherein the tostada dough further comprises a taco shell dough to be used to create a controlled-break taco shell.

4. The method of claim 3 wherein the taco shell dough is selected from a group of corn-based dough, wheat-based dough, rice-based dough, and any combinations thereof.

5. The method of claim 1 wherein cutting the break-points throughout the surface of the tostada dough with the cutting device further comprises placing holes with a separation within a range of 0.20 cm to 0.30 cm between each other.

6. The method of claim 1, wherein heating the tostada dough further comprises baking the tostada dough in an oven.

7. The method of claim 1, wherein heating the tostada dough further comprises frying the tostada dough in a fry machine.

8. A controlled-break tostada comprising a tostada with break-points throughout surface of the tostada with a separation within a range of 0.20 cm to 0.30 cm between each other.

9. The controlled-break tostada of claim 8 wherein the controlled-break tostada further comprises a diameter in a range from about 4 inches to about 16 inches from a circular edge of the tostada to an opposite circular edge.

10. The controlled-break tostada of claim 8 wherein the controlled-break tostada further comprises tostada dough selected from a group of corn-based dough, wheat-based dough, rice-based dough, and any combinations thereof.

11. A controlled-break taco shell comprising a taco with break-points throughout surface of the taco shell with a separation within a range of 0.20 cm to 0.30 cm between each other.

12. The controlled-break taco shell of claim 11 wherein the controlled-break taco shell further comprises a diameter in a range from about 4 inches to about 16 inches from a circular edge of the taco shell to an opposite circular edge.

13. The controlled-break taco shell of claim 11 wherein the controlled-break taco shell further comprises taco shell dough selected from a group of corn-based dough, wheat-based dough, rice-based dough, and any combinations thereof.
